(19) United States
(12) Patent Application Publication
(10) Pub. No.: US 2019/0307078 A1
(43) Pub. Date: Oct. 10, 2019

(54) Container for Growing of Cannabis

(71) Applicant: Delta 9 Bio-Tech Inc., Winnipeg (CA)

(72) Inventor: John William Arbuthnot, III, Winnipeg (CA)

(21) Appl. No.: 15/948,719

(22) Filed: Apr. 9, 2018

(51) Int. Cl. A01G 9/24; A01G 9/20; B65D 88/74

(52) U.S. Cl. CPC A01G 9/246; A01G 7/045; B65D 88/74; A01G 9/20

(57) ABSTRACT

Apparatus for growing Cannabis is created from a conventional rectangular shipping container with fork lifting channels in the floor and having stacking connectors by which one container can be stacked on another and includes standing plant support racks arranged at stationary positions along sides of the container for receiving plants thereon at a selected stage of growth, typically the flowering stage. First and second rows of lighting components are arranged on respective sides each with a cooling duct extending from a filtered inlet at the front to an extraction fan at the rear. The lighting is carried on two longitudinal cable rails each along a respective side. The air-conditioning system includes two exterior condensers mounted on the rear panel above the center line each supplying at least two interior evaporators. The front panel of the container is removed and replaced by a new front panel with a central door.

This invention relates to a container or grow pod for use in the growing of Cannabis. Various stages of growth can be housed in the container herein but the design is particularly directed to and designed for the nursery stage from commencement of the propagation to full maturity and flowering of the plant.

### BACKGROUND OF THE INVENTION

Growth of Cannabis in an indoor facility raises a number of issues in that the facility should be secure from pest or human intrusion, should be closed so as to avoid release of pungent odors, and should properly provide the necessary growth conditions inside the facility, such as airflow, watering, nutrition, temperature controls among others, in a manner which allows the conditions to be varied to manage the growth and flowering of the plants.

Attempts have been made previously to use an existing structure to provide the exterior body of the container by using conventional shipping containers which are readily and widely available and to modify the container to achieve the required controlled growth conditions inside the container yet have left out key components that help create an efficient growing appliance.

### SUMMARY OF THE INVENTION

It is an object of the present invention to provide a container for use in growing Cannabis.

According to the invention there is provided an apparatus for growing plants and particularly Cannabis comprising:

an enclosed rectangular container having a horizontal floor, a horizontal roof and four vertical walls including two side walls, a rear wall and a front wall;

a plurality of racks arranged along sides of the container for receiving plants thereon at a selected stage of growth;

lighting components arranged at spaced positions along the container for illuminating the plants;

an air-conditioning system for cooling the interior of the container having interior cooling components for directing cooling air into the interior and exterior heat releasing components mounted on an exterior of the container;

an entrance door which can be opened to allow access to the interior and can be locked to secure against unauthorized access;

an air filtration system for filtering air passing between the interior and the exterior;

and an electrical control system for controlling the lighting system;

wherein the container comprises a shipping container with fork lifting channels in the floor and having stacking connectors by which one container can be easily assembled, transported and stacked on another.

In accordance with a first important feature of the invention, the front end wall comprises a replacement panel welded onto the front of the side walls, floor and roof to replace existing front end doors, the replacement panel having a single door located substantially centrally between the side walls with a fixed panel portion between each side edge of the door and an adjacent one of the side walls and with a panel portion above the door to the roof. This enables the door to allow access to a central aisle within the container between the two rows of racks one to each side. The front panel containing the door can also provide a support for the air filtration system, the lighting cooling system, the nutrient supply, the security access system and any other requirements.

Another feature provides a pair of cable support racks mounted on the ceiling along which cabling is carried each adjacent a respective one of the side walls. This allows the necessary electrical cabling to be simply looped into place within the rack without the necessity for other conduits or fastening systems. The same racks can provide support for the lighting components which simply are hung on the cable support racks to depend therefrom to provide support along the full length of the container adjacent the roof without the necessity for other structural members.

Preferably each cable support rack comprises a plurality of longitudinally spaced bent wire supports at spaced positions along the rack, each wire support bent to form a top rail attached to the roof, a depending side arm on one side, a bottom support rail and an upstanding second side to allow insertion of the cables through an opening at a top of the second side onto the bottom support rail for support thereby. The rack can thus provide a wide enough container for a number of cables or other conduits as required.

In accordance with another important feature of the invention, each of the rows of lighting components are connected each to the next by a lighting cooling system, where individual light housings are connected to a cylindrical duct along the full length of the container. The duct thus is connected at each end to openings the front and rear panels to allow passage of air along the duct to simultaneously cool all of the lighting fixtures. Suitable lighting fixtures are available commercially using LED or other technologies. Such lighting components typically comprises a reflector directing light downwardly through a transparent bottom onto the plants on the rack. In this way the air drawn along the duct from a filtered inlet at the front wall for inlet air to a suction outlet at the rear wall acts for drawing air out of the duct for cooling effectively all of the lighting components in the row.

In accordance with another feature, the air condition system includes two separate exterior heat releasing components or condensers which are located each on a respective side of a vertical center line of the rear wall and each above a horizontal center line. This ensures that the emitted heat is released in a controlled manner to the top of the container and not at the area where passing persons or other equipment may be influenced.

Preferably each condenser cooperates with a respective one of two sets of interior cooling components or evaporators each on a respective side of a center line of the container and each including two or more components at spaced positions along the container. This ensures effective release of the cooled air into the interior to maintain all plants along the row in proper condition.

The walls of the container are painted to provide a clean effective white interior which is resistant to contamination to maintaining the necessary hygienic standards and preferably floor comprises a wooden sub-frame covering a steel base of the container with a vinyl or similar layer of sheet floor material laid over the sub-frame. This sheet may be bonded to the subfloor to maintain an effective and smooth surface which is resistant to collection of materials which could interfere with the hygiene.

To provide effective control of the interior systems to provide the necessary control to manage the growth characteristics, each of two air-conditioning systems and each of the rows of lighting is controlled by a respective one of two separate electrical control panels on the rear wall which are split and designed to control each side separately.

Preferably the air-conditioning system comprises an AC power source which is separated from other energy sources to reduce heating outside the container.

Preferably there is provided a filtration system to prevent odour passing from inside the container to outside atmosphere. Typically this can be mounted at the front wall on the panels either side of or above the central door

Using a conventional shipping container as the basic body of the container provides conventional fork lift pockets on the outside surface of each side of the container to allow lifting of the container from those pockets for movement and stacking of the container to provide many different layouts of the grow pods to quickly and easily modify the location of the pods or the number of pods used in a certain stage of the process. For this reason connectors can be provided for when stacking of two containers is required for example when the pods are taken out of service.

In order to allow the use of the existing container, all the tie hooks on the floor of the container are removed and grinded smooth.

For the growth of Cannabis, the racks typically comprise simple stands with a horizontal support surface for plant containers and legs standing in stationary position on the floor adjacent respective side walls with the nutrient supply underneath the support surface. The nutrient liquid supply is typically located at the front wall for easy filling and replacement and passes through the front panel with a drain pipe return located at a position on the rear wall raised from the floor.

The container used needs to be a “once used” or new shipping container that meets all ISO (International Standards Organization) standards. The containers needs to be a high cube style container.

Dimensions for the grow pods are.

| | Length | Width | Height |
|---|---|---|---|
| Overall | 40′ = | 8′ = | 9′-6″ = |
| | 12192 mm | 2438 mm | 2896 mm |
| Inside | 39′ 3.24″ = | 7′ 8.5″ = | 8′ 10″ = |
| | 12022 mm | 2352 mm | 2692 mm |

The containers are light in colour on the inside and out from the shipping company. This is to insure that the finish paint colour is as white and bright as specified in the painting specifications.

The containers have fork lift pockets on the side of each side of the container to allow lifting of the container from those pockets.

The container is selected of the type which has doors only on one end of the container. The doors are removed to allow for an end panel with central entry door to be installed.

All the tie hooks on the floor of the container are removed and grinded smooth for flooring preparation.

All the container door latch hook in points from the original doors are grinded off and made flush with the rest of the container.

All the silicone that is along the corrugated wall edge and where the floor meet, is ground off and removed prior to painting and flooring.

For every container delivered two container connectors are required for when stacking is required.

The container is placed in a clean room or clean building for the painting and flooring. The building is heated to at least 15 degrees C. for proper glue adhesion and paint adhesion. The room or building is ventilated to allow for safe application of the flooring and paint.

The following steps are followed to convert the container to the growth container herein:

-a- Cover and protect a/c units, plywood floor perimeter, electrical panel, electrical devices. Wash the entire exterior and interior of the container using a high pressure sprayer.

-b- Apply paintable silicone caulking to interior and exterior seams in both the front and back of the container. DAP Alex plus or equivalent caulking.

-c- Apply 1 coat to the interior and exterior of the container with 4360 Devflex metal primer, including all conduit and metal hardware inside the container.

-d- Apply 2 coats of 16-510c Pitt-Glaze single component water base epoxy.

-e- Clean pressure wash floor prior to application of any primers or vinyl.

-f- Allow sufficient time for the floor to dry prior to application of primers or patch compound.

-g- Apply Uzin 280 primer/sealer to plywood floor.

-h- Apply Uzin 414 primer/sealer to plywood floor.

-j- Lay down fiber glass mesh matt on entire floor area.

-k- Apply Uzin 150 self- leveling compound over plywood floor. Apply a ¼ inch thick layer that is to be saturated with the fiber glass mesh. A spike roller is needed to combine the leveling compound with the fiber glass mesh matt.

-l- Patch floor as required after self- leveling compound is set. The floor is to be smooth and level when the vinyl is applied to the container. No visible depressions or uneven surfaces is acceptable once the vinyl is applied.

-m- Supply and install Forbo Sphera (single layer vinyl with anti-microbial properties) using vinyl adhesive, w/40′ welded seam running length of container. Cut vinyl to fit along corrugated metal container walls.

-n- Apply silicone to floor perimeter along corrugated metal walls and floor seam to all 4 sides.

-p- The vinyl needs to follow the corrugations and be within 5 mm of the corrugation of the walls around the entire container. Any larger gaps than the 5 mm and the container will be rejected.

In order for the end panel to be welded on the end of the container the paint needs to be grinded away from the areas where the end panel will be welded to the container.

The end panel will need to be cleaned with a suitable cleaner prior to welding and or painting.

All the container door latch hook-in points from the original doors are grinded off and made flush with the rest of the container.

The end panel is attached using 1 inch long stitch welds every 8 inches around the entire end panel. Every door needs to be matched up with every opening to verify that the door will open and close properly. No more than a ¼ inch gap around the door frame to the door is acceptable.

The end panel is to be square and level to the container opening.

This type of flowering container requires two air conditioning units. A suitable unit which can be used in these containers is Carrier Model 8MHRQ12A-3

### BRIEF DESCRIPTION OF THE DRAWINGS

One embodiment of the invention will now be described in conjunction with the accompanying drawings in which:

FIG. 1 is top plan view of the container according to the present invention with the top wall removed to show the interior components.

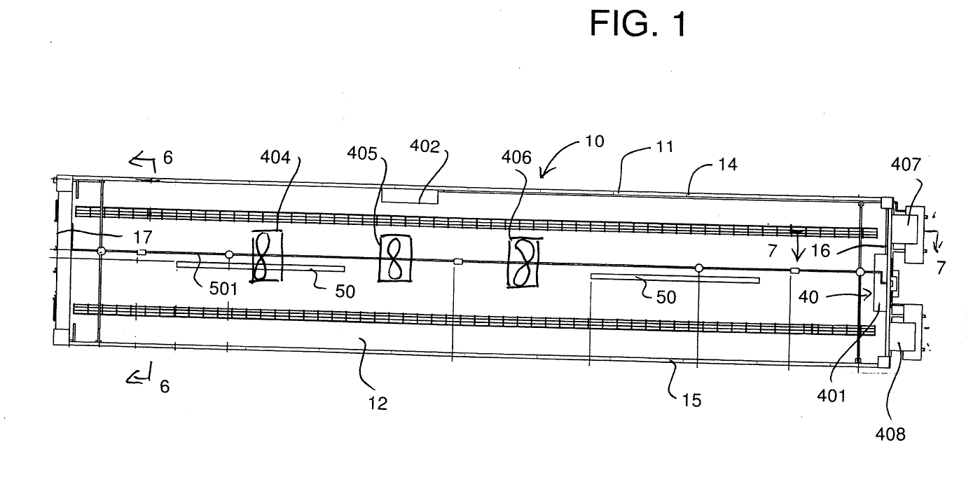

FIG. 2 is a top plan view similar to that of FIG. 1 on an enlarged scale showing only the front end of the container.

FIG. 3 is a top plan view similar to that of FIG. 1 on an enlarged scale showing only the rear end of the container.

FIG. 4 is an exterior view of the rear end wall of the container of FIG. 1.

FIG. 5 is an exterior view of the front end wall of the container of FIG. 1.

FIG. 6 is a cross-sectional view along the lines 6-6 of the container of FIG. 1.

FIG. 6A is a cross-sectional view along the lines 6-6 of the container of FIG. 1 on an enlarged scale to show the lighting and conduit rack in more detail.

FIG. 7 is a cross-sectional view along the lines 7-7 of the container of FIG. 1.

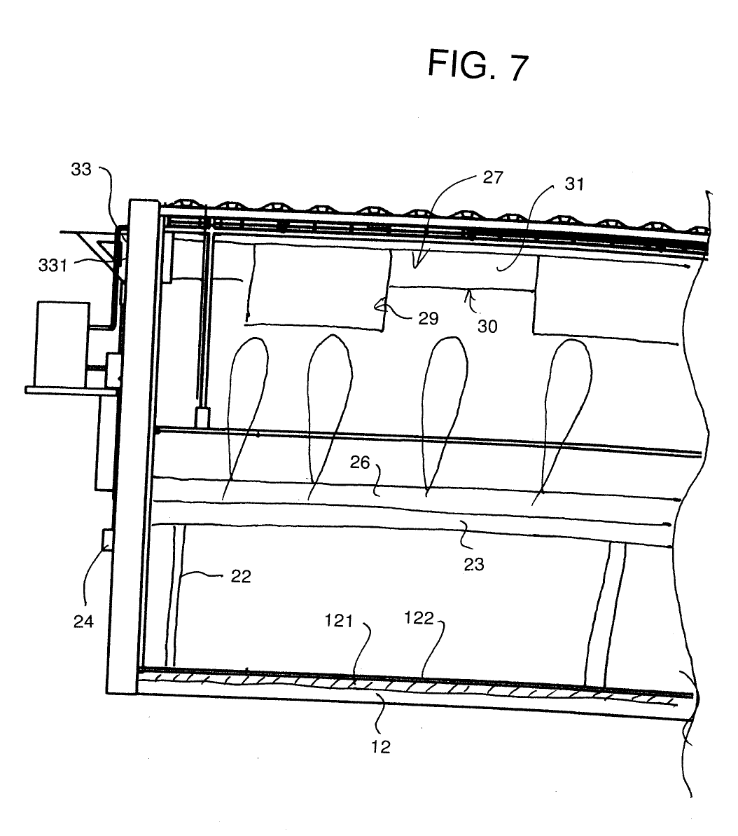

In the drawings like characters of reference indicate corresponding parts in the different figures.

### DETAILED DESCRIPTION

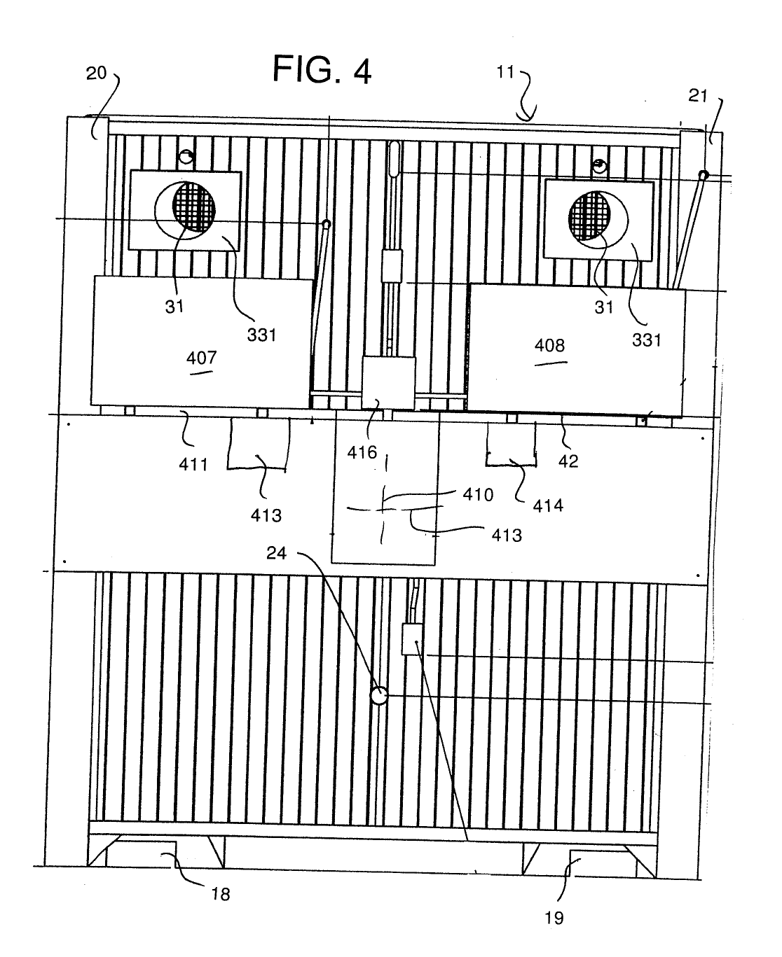

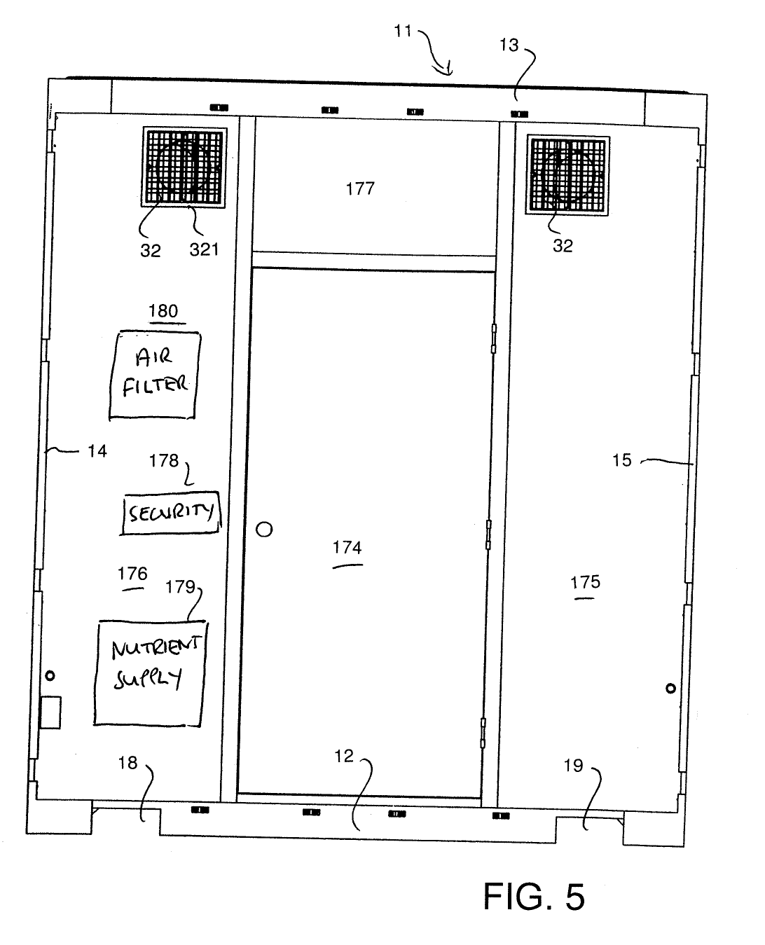

An apparatus 10 for growing plants includes an enclosed rectangular container having a horizontal floor 12, a horizontal roof 13 and four vertical walls including two side walls 14, 15, a rear wall 16 and a front wall 17. The container comprises a shipping container of a conventional nature which as manufactured for shipping uses includes fork lifting channels 18, 19 (FIGS. 4 and 5) in the floor and stacking connectors 20, 21 at the top corners by which one container can be stacked on another. Preferably the fork lift pockets are provided at each end of the container to allow lifting of the container from those pockets. However other locations can be used.

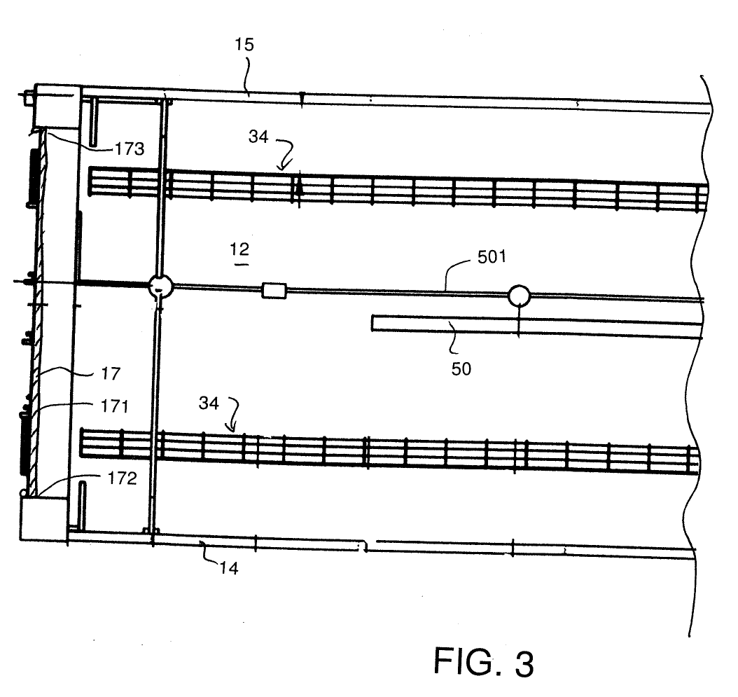

As best shown in FIG. 3 and described before, the front end wall comprises a replacement panel 171 welded onto the front of the side walls 14, 15, floor 12 and roof to replace existing front end doors. That is conventional shipping containers have two wide opening doors at the front which meet at a center line. These doors are removed by cutting and the replacement panel is welded in place at weld lines 172, 173. The replacement panel closes the front end but provides a single door 174 located substantially centrally between the side walls 14, 15 with a fixed panel portion 175, 176 between each side edge of the door and an adjacent one of the side walls 14, 15. The door opens outwardly to allow access by workers to the channel along the center of the container on either side of two rows of plants. The door also allows access for harvesting the plants. As shown the door is located directly at the center and this is much preferred. However other arrangements can have the door offset to one side so that the panel 175 is larger or smaller than the opposite panel 176. A top panel 177 extends between the top of the door and the roof.

The front panels 175 and 176 provide fixed access for operating systems of the container including a door security system 178, an air filter system 180 and a nutrient supply container 179.

The interior wall surfaces of the side, front and rear walls and the roof are painted bright white.

At the floor, all the tie hooks on the floor of the container are removed and grinded smooth to provide a smooth interior surface of the floor. This is covered by a wooden sub-frame 121 covering a steel base of the container with a sheet floor material 122 laid over the sub-frame 121 to provide a continuous smooth clean layer extending from each side and end wall across the full extent of the floor.

In order to support the plants for growth, the container includes longitudinal racks in the form of a plurality of standing racks 22 arranged along respective sides of the container for receiving plants thereon at the selected stage of growth. The racks thus leave a path between the racks from the door along the full length of the container to allow the worker to access the plants as required on each side. Each rack carries a nutrient bath 23 carried on the rack which is supplied with flowing nutrient liquid from the supply 179. A suitable pump carries the liquid to each bath and excess returns through a drain 24 in the rear wall as shown in 7, located centrally in the rear wall at a height spaced form the floor 12. On top of each nutrient bath is placed the containers for the plants as indicated at 26 from which the plants can grow to the required height defined by the distance between the container and the lighting system.

The lighting comprises first and second rows 27, 28 of lighting components 29 each row being arranged adjacent a respective side of the container and each including the components 29 thereof arranged at spaced positions along the container for illuminating the plants. Each component 29 of the rows 27, 28 of lighting components is connected each to the next by a lighting cooling system 30 defined by a cylindrical duct 31 along the full length of the container which has an inlet 32 mounted in an inlet filter box 321 at the front wall 17 for inlet air and a suction outlet 33 including a suction fan 331 at the rear wall for drawing air through the duct 31 and though each light housing for cooling each of the lighting components in the row. Each lighting component 29 comprises a reflector 291 containing a plurality of light emitting elements directing light downwardly through a transparent bottom 292 onto the plants on the rack.

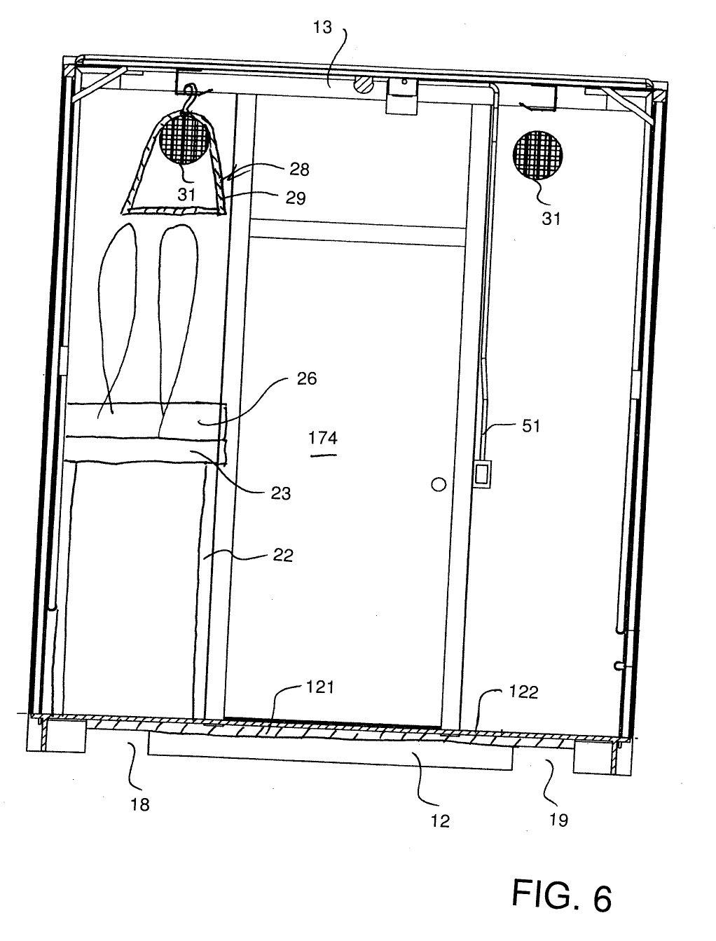

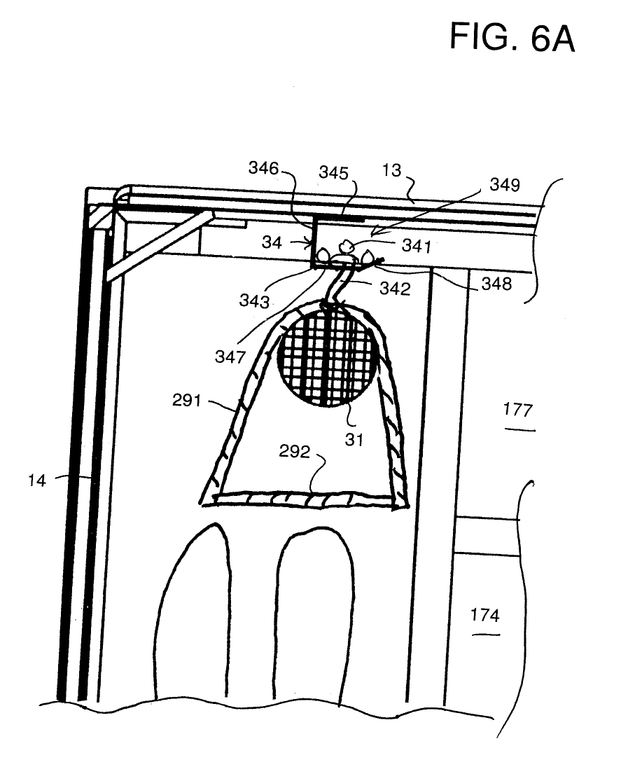

As shown best in FIG. 6A, there is provided a pair of cable support racks mounted 34 attached on the underside of the roof 13 adjacent a respective one of the side walls along which cabling 341 is carried. The racks provide a simple support for the lighting components and the duct 31 which are hung on the cable support racks by suitable hangers 342.

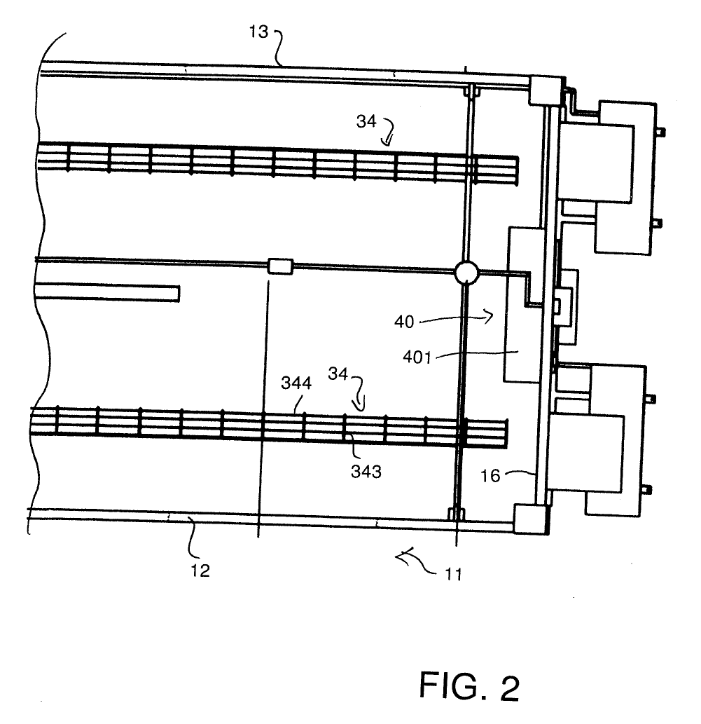

Each cable support rack comprises a plurality of longitudinally spaced bent wire supports 343 at spaced positions along the rack. With longitudinal connecting wires 344 (FIG. 2). Each wire support 343 is bent to form a top rail 345 attached to the roof, a depending side arm 346 on one side, a bottom support rail 347 on which the cables sit and an upstanding second side 348 to allow insertion of the cables 341 through an opening 349 at a top of the second side 348 so as to lie on the bottom support rail 347.

An air-conditioning system 40 for cooling the interior of the container includes two interior cooling components 401 and 402 for directing cooing air into the interior. The unit 401 is mounted at the top of the rear wall. The unit 402 is mounted at the top of the wall 14 adjacent the center of the container. These both direct cooling air into the interior which is then spread by a series of fans 404, 405 and 406 along the center suspended from the rood 12. The cooling effect is generated by two exterior heat releasing components 407, 408, shown best in FIG. 4, mounted on an exterior of the container. The two exterior heat releasing components 407, 408 are carried on support shelfs 411 and 412 each on a respective side of a vertical center line 410 of the rear wall and each above a horizontal center line 413. However the A/C components on the exterior can comprise a single component and this can be mounted at any location on the rear wall. Interior green worker lighting 50 is provided to allow access without disturbing the plants and is controlled by wiring controls 501.

Each of two air-conditioning systems and each of the rows of lighting is controlled by a respective one of two separate electrical control panels 413 and 414 on the rear wall which are split and designed to control each side separately. These are plugged into the power boxes each defining an eight outlet power box located directly under the NC condenser on each side.

An air filtration system for filtering air passing between the interior and the exterior; to prevent odour passing from inside the container to outside atmosphere.

The air-conditioning system comprises an AC power source 416 which is separated from other energy sources to reduce heating outside the container. There are two condensers mounted outside 407, 408 and two evaporators located inside 401, 402. They are wired in through a separate power box 416, then wired into the electrical panel with two 15 Amp breakers.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for growing plants comprising:
an enclosed rectangular container having a horizontal floor, a horizontal roof and four vertical walls including two side walls, a rear wall and a front wall;
a plurality of racks arranged along sides of the container for receiving plants thereon at a selected stage of growth;
lighting components arranged at spaced positions along the container for illuminating the plants;
an air-conditioning system for cooling the interior of the container having interior cooling components for directing cooing air into the interior and exterior heat releasing components mounted on an exterior of the container;
an entrance door which can be opened to allow access to the interior and can be locked to secure against unauthorized access;
and an electrical control system for controlling the lighting system;
wherein the container comprises a shipping container with fork lifting channels in the floor and having stacking connectors by which one container can be stacked on another.

2. The apparatus according to claim 1 wherein the front end wall comprises a replacement panel welded onto the front of the side walls, floor and roof to replace existing front end doors, the replacement panel having a single door located substantially centrally between the side walls with a fixed panel portion between each side edge of the door and an adjacent one of the side walls.

3. The apparatus according to claim 1 wherein there is provided a pair of cable support racks mounted on the ceiling along which cabling is carried each adjacent a respective one of the side walls.

4. The apparatus according to claim 1 wherein the lighting components are hung on the cable support racks.

5. The apparatus according to claim 1 wherein each cable support rack comprises a plurality of longitudinally spaced bent wire supports at spaced positions along the rack, each wire support bent to form a top rail attached to the roof, a depending side arm on one side, a bottom support rail and an upstanding second side to allow insertion of the cables through a opening at a top of the second side onto the bottom support rail.

6. The apparatus according to claim 1 wherein each of the rows of lighting components are connected each to the next by a lighting cooling system, where individual light housings are connected to a cylindrical duct along the full length of the container.

7. The apparatus according to claim 1 wherein each lighting component comprises a reflector directing light downwardly through a transparent bottom onto the plants on the rack.

8. The apparatus according to claim 1 wherein the cylindrical duct has a filtered inlet at the front wall for inlet air and a suction outlet at the rear wall for drawing air out of the duct for cooling the lighting components in the row.

9. The apparatus according to claim 1 wherein two exterior heat releasing components are located each on a respective side of a vertical center line of the rear wall and each above a horizontal center line.

10. The apparatus according to claim 1 wherein there are two sets of interior cooling components each on a respective side of a center line of the container and each including two or more components at spaced positions along the container.

11. The apparatus according to claim 1 wherein the floor comprises a wooden sub-frame covering a steel base with a sheet floor material laid over the sub-frame.

12. The apparatus according to claim 1 wherein each of two air-conditioning systems and each of the rows of lighting is controlled by a respective one of two separate electrical control panels on the rear wall which are split and designed to control each side separately.

13. The apparatus according to claim 1 wherein the air-conditioning system comprises an AC power source which is separated from other energy sources to reduce heating outside the container.

14. The apparatus according to claim 1 wherein there is provided a filtration system to prevent odour passing from inside the container to outside atmosphere.

15. The apparatus according to claim 1 wherein the interior wall surfaces are painted bright white.

16. The apparatus according to claim 1 wherein fork lift pockets are provided on the side of each side of the container to allow lifting of the container from those pockets.

17. The apparatus according to claim 1 wherein connectors are provided for when stacking of two containers is required.

18. The apparatus according to claim 1 wherein all the tie hooks on the floor of the container are removed and grinded smooth.

19. The apparatus according to claim 1 wherein the racks comprise stands with a horizontal support surface for plant containers and legs standing in stationary position on the floor adjacent respective side walls.

20. The apparatus according to claim 1 wherein there is provided a nutrient liquid supply with a drain pipe return located at a position on the rear wall raised from the floor.

21. The apparatus according to claim 1 wherein the lighting components comprise first and second rows of lighting components each row being arranged adjacent a respective side of the container and each including the components thereof arranged at spaced positions along the container for illuminating the plants.
